(19) United States
(12) Patent Application Publication
(10) Pub. No.: US 2015/0045571 A1
(43) Pub. Date: Feb. 12, 2015

(54) Method for Preparing an Organofunctional Compound

(71) Applicant: Dow Corning Corporation, Midland, MI (US)

(72) Inventors: Dimitris Katsoulis, Midland, MI (US); Robert Larsen, Midland, MI (US)

(21) Appl. No.: 14/381,995

(22) PCT Filed: Feb. 15, 2013
(86) PCT No.: PCT/US13/26288

§ 371 Date: Aug. 29, 2014

Related U.S. Application Data
(60) Provisional application No. 61/620,546, filed on Apr. 5, 2012.

(51) Int. Cl. C07F 7/30

(52) U.S. Cl. CPC C07F 7/30
USPC 556/99

(57) ABSTRACT

Claimed is a method for making an organofunctional compound of formula R_{b}M_{c}X_{d} comprising the following steps: (i) contacting a transition metal catalyst with a mixture including hydrogen gas and a halide of formula MXₐ to form a M-containing transition metal catalyst; (ii) contacting the M-containing transition metal catalyst with an organohalide to form the organofunctional compound of formula R M_{c}X_{d}. In the above formulae, M is an element selected from antimony, arsenic, bismuth, boron, cadmium, gallium, germanium, indium, lead, mercury, phosphorus, selenium, sulfur, tellurium, and tin. X is a halogen atom or a hydrogen atom. Subscripts have values matching the valences. R is a monovalent organic group. Examples of species of the organofunctional compound prepared according to the method described above include dimethyldichlorogermane (i.e., (CH3)2GeCl2), dimethyldibromogermane, dimethyldiiodogermane, dimethyldifluorogermane, diethyldichlorogermane, diethyldibromogermane, diethyldiiodogermane, dicyclohexyldichlorogermane, and dicyclohexyldibromogermane. The process may also produce other organofunctional compounds, such as those having the formulae ReHGeX3−e, RGeX3, and/or R3GeX, where R and X are as defined above and subscript e is 1 or 2. The method may also produce hydrohalogermanium compounds (i.e., hydrohalogermanes), such as those having the formula HGeX3, where X is as defined above.

Synthesis or production of some organofunctional compounds such as organophosphorus, organoboron, and other organofunctional compounds can be energy intensive, difficult and/or expensive, and/or thermodynamically unfavored. There is a need in industry for improved methods to produce organofunctional compounds that minimize some or all of these drawbacks.

### BRIEF SUMMARY OF THE INVENTION

A method for preparing an organofunctional compound comprises steps (i) and (ii), wherein step (i) comprises contacting a transition metal catalyst with a mixture comprising hydrogen gas and a halide of formula MXₐ, where M is an element selected from the group consisting of Sb, As, Bi, B, Cd, Ga, Ge, In, Pb, Hg, P, Se, S, Te, and Sn; each X is independently a halogen or hydrogen atom, and subscript a has a value matching the valence of the element selected for M; at a temperature ranging from 200° C. to 1400° C. to form a M-containing transition metal catalyst comprising at least 0.1% of M; and step (ii) comprises contacting the M-containing transition metal catalyst with an organohalide at a temperature ranging from 100° C. to 600° C. The method forms a product comprising an organofunctional compound of formula R_{b}M_{c}X_{d}, where each R is independently a monovalent organic group, subscript b is 1 or more, subscript c is 1 or more, subscript d is 0 or more, and a quantity (b+d) has a value matching the valence of M_{c}.

### DETAILED DESCRIPTION OF THE INVENTION

The Brief Summary of the Invention and the Abstract are hereby incorporated by reference. All ratios, percentages, and other amounts are by weight, unless otherwise indicated. The prefix “poly” means more than one. Abbreviations used herein are defined in Table 1, below.

TABLE 1
Abbreviations

| Abbreviation | Word |
|---|---|
| % | percent |
| ° C. | degrees Celsius |
| Bu | “Bu” means butyl and includes various structures including |
| | nBu, sec-butyl, tBu, and iBu. |
| iBu | isobutyl |
| nBu | normal butyl |
| tBu | tertiary butyl |
| cm | centimeter |
| Et | ethyl |
| g | gram |
| GC | gas chromatograph and/or gas chromatography |
| hr | hour |
| ICP-AES | inductively coupled plasma atomic emission spectroscopy |
| ICP-MS | inductively coupled plasma mass spectrometry |
| kPag | kilopascals gauge |
| Me | methyl |
| mg | milligram |
| Min | minutes |
| mL | milliliters |
| Ph | phenyl |
| Pr | “Pr” means propyl and includes various structures such as iPr |
| | and nPr. |
| iPr | isopropyl |
| nPr | normal propyl |
| s | seconds |
| sccm | standard cubic centimeters per minute |
| TCD | thermal conductivity detector |
| uL | microliter |
| Vi | vinyl |

The disclosure of ranges includes the range itself and also anything subsumed therein, as well as endpoints. For example, disclosure of a range of 2.0 to 4.0 includes not only the range of 2.0 to 4.0, but also 2.1, 2.3, 3.4, 3.5, and 4.0 individually, as well as any other number subsumed in the range. Furthermore, disclosure of a range of, for example, 2.0 to 4.0 includes the subsets of, for example, 2.1 to 3.5, 2.3 to 3.4, 2.6 to 3.7, and 3.8 to 4.0, as well as any other subset subsumed in the range. Similarly, the disclosure of Markush groups includes the entire group and also any individual members and subgroups subsumed therein. For example, disclosure of the Markush group, alkyl, alkenyl, alkynyl, and carbocyclic groups includes the member alkyl individually; the subgroup alkyl and alkenyl; and any other individual member and subgroup subsumed therein.

“Alkyl” means an acyclic, branched or unbranched, saturated monovalent hydrocarbon group. Examples of alkyl groups include Me, Et, Pr, 1-methylethyl, Bu, 1-methylpropyl, 2-methylpropyl, 1,1-dimethylethyl, pentyl, 1-methylbutyl, 1-ethylpropyl, pentyl, 2-methylbutyl, 3-methylbutyl, 1,2-dimethylpropyl, 2,2-dimethylpropyl, hexyl, heptyl, 2-ethylhexyl, octyl, nonyl, and decyl.

“Aralkyl” and “alkaryl” each refer to an alkyl group having a pendant and/or terminal aryl group or an aryl group having a pendant alkyl group. Exemplary aralkyl groups include benzyl, tolyl, xylyl, phenylethyl, phenyl propyl, and phenyl butyl.

“Alkenyl” means an acyclic, branched, or unbranched unsaturated monovalent hydrocarbon group, where the monovalent hydrocarbon group has a double bond. Alkenyl groups include Vi, allyl, propenyl, and hexenyl.

“Alkynyl” means an acyclic, branched, or unbranched unsaturated monovalent hydrocarbon group, where the monovalent hydrocarbon group has a triple bond. Alkynyl groups include ethynyl and propynyl.

“Carbocycle” and “carbocyclic” refer to a hydrocarbon ring. Carbocycles may be monocyclic or alternatively may be fused, bridged, or spiro polycyclic rings. Monocyclic carbocycles may have 3 to 9 carbon atoms, alternatively 4 to 7 carbon atoms, and alternatively 5 to 6 carbon atoms. Polycyclic carbocycles may have 7 to 17 carbon atoms, alternatively 7 to 14 carbon atoms, and alternatively 9 to 10 carbon atoms. Carbocycles may be saturated or partially unsaturated.

“Cycloalkyl” refers to a saturated hydrocarbon group including a carbocycle. Cycloalkyl groups are exemplified by cyclobutyl, cyclopentyl, cyclohexyl, and methylcyclohexyl.

“Metallic” means that the metal has an oxidation number of zero.

“Purging” means to introduce a gas stream to the reactor containing the M-containing transition metal catalyst to remove unwanted gaseous or liquid materials.

“Residence time” means the time for one reactor volume of reactant gases to pass through a reactor charged with catalyst. (E.g., the time for one reactor volume of hydrogen and halide in step (i) to pass through a reactor charged with transition metal catalyst or the time for one reactor volume of organohalide to pass through a reactor charged with M-containing transition metal catalyst in step (ii) of the method described herein.)

“Spent M-containing transition metal catalyst ” refers to refers to the M-containing transition metal catalyst after it has been contacted with the organohalide in step (ii) (or after step (iv), when step (iv) is present in the method). The spent M-containing transition metal catalyst after step (ii) (or step (iv)) contains an amount of element M less than the amount of element M in the M-containing transition metal catalyst after step (i) and before beginning step (ii) (or after step (iii) and before beginning step (iv)). Spent M-containing transition metal catalyst may, or may not, be exhausted.

The method comprises step (i) and step (ii). Step (i) and step (ii) of the method may be conducted separately and consecutively. Separately means that step (i) and step (ii) do not overlap or coincide. Consecutively means that step (ii) is performed after step (i) in the method; however, additional steps may be performed between step (i) and (ii), as described below. “Separate” refers to either specially or temporally or both. “Consecutive” refers to temporally (and furthermore occurring in a defined order).

Step (i) comprises contacting a transition metal catalyst with a mixture comprising hydrogen gas and a halide of formula MXₐ, where M is an element selected from the group consisting of Sb, As, Bi, B, Cd, Ga, Ge, In, Pb, Hg, P, Se, S, Te, and Sn; each X is independently a halogen or hydrogen atom, and subscript a has a value matching valence of M; at a temperature ranging from 200° C. to 1400° C. to form a M-containing transition metal catalyst comprising at least 0.1% of element M. Without wishing to be bound by theory, if in the halide of formula MXₐ the element selected for M is a transition metal (such as Cd or Hg), then the transition metal catalyst would contain a different transition metal than that selected for M (such as Cu).

Step (ii) comprises contacting the M-containing transition metal catalyst with an organohalide at a temperature ranging from 100° C. to 600° C. The organohalide may have formula RX, where R is a monovalent organic group and X is a halogen atom. The halogen atom selected for X in the organohalide may be the same as the halogen atom selected for X in the halide used in step (i). Alternatively, the halogen atom selected for X in the organohalide may differ from the halogen atom selected for X in the halide used in step (i). The product of step (ii) comprises at least one organofunctional compound of formula R_{b}M_{c}X_{d}, where each R is independently a monovalent organic group, subscript b is 1 or more, subscript c is 1 or more, subscript d is 0 or more and a quantity (b+d) has a value matching valence of M_{c}.

The transition metal catalyst used in step (i) may comprise a transition metal selected from the group consisting of Cu, Fe, Co, Ni, Mo, Ru, Rh, Pd, Ag, Re, Os, Ir, Pt, Au, and a combination thereof. Alternatively, the transition metal catalyst may be a mixture comprising one or more of the transition metals described above and a material such as magnesium, calcium, cesium, tin, or sulfur, or halide, silicide, carbide, or oxide of such a material (e.g., MgCl₂). The transition metal catalyst may comprise an amount of transition metal ranging from 0.1% to less than 100%, alternatively 50% to less than 100%, alternatively 70% to less than 100%, and alternatively 80% to 99.9%; based on the total weight of the transition metal catalyst, with the balance being at least one of the elements described above.

The transition metal catalyst can be a supported or unsupported catalyst. Examples of supports include, but are not limited to, oxides of aluminum, titanium, zirconium, and silicon; activated carbon; carbon nanotubes; fullerenes; and other allotropic forms of carbon. Alternatively, the support may be activated carbon.

When the transition metal catalyst comprises a support, the catalyst may comprise an amount ranging from 0.1% to less than 100%, alternatively 0.1% to 50%, and alternatively 0.1% to 35%, of transition metal (or the mixture described above), based on the combined weight of the support and transition metal (or the combined weight of the support and the mixture, when the mixture described above is used).

The transition metal catalyst can have a variety of physical forms including, but not limited to, lumps, granules, flakes, and powder.

Alternatively, the transition metal catalyst used in step (i) may be a copper catalyst. The copper catalyst used in step (i) can be selected from the group consisting of copper and a mixture comprising copper and at least one element selected from gold, magnesium, calcium, cesium, tin, and sulfur. The mixture may comprise an amount of copper ranging from 0.1% to less than 100%, alternatively 50% to less than 100%, alternatively 70% to less than 100%, and alternatively 80% to 99.9%; based on the total weight of the mixture, with the balance of the mixture being at least one of the elements described above. The copper catalyst may be unsupported or supported.

Examples of the unsupported copper catalyst include, but are not limited to, metallic copper; mixtures of metallic copper and gold; mixtures of metallic copper, metallic gold and magnesium chloride; mixtures of metallic copper, metallic gold and sulfur; mixtures of metallic copper and tin; mixtures of metallic copper and cesium; and mixtures of metallic copper and calcium chloride. Alternatively, the copper catalyst may include an alloy of copper and one of the elements selected from the group consisting of magnesium, gold, sulfur, tin, cesium, and calcium.

Examples of the supported copper catalyst include the unsupported copper catalysts described above on an activated carbon support, where the supported copper catalyst comprises 0.1% to 35%, of copper (or the mixture), based on the combined weight of the support and copper (or the mixture).

The unsupported and supported copper catalysts can be made by processes known in the art. For example, to make the unsupported catalyst, copper, gold, magnesium chloride, tin, and calcium may be mixed to form the copper catalysts. In addition, metal salts, including, but not limited to, halide, acetate, nitrate, and carboxylate salts, may be mixed in desired proportions and then subjected to known reduction processes. One such reduction process for making the supported copper catalysts is described in PCT Publication No. WO2011/149588. This process may leave some salts, such as magnesium chloride, unreduced, while reducing others. Some of these catalysts are also available commercially.

The halide used in step (i) has the formula MXₐ. In this formula, M is an element selected from the group consisting of Sb, As, Bi, B, Cd, Ga, Ge, In, Pb, Hg, P, Se, S, Te, and Sn. Alternatively, M may be B, Ge, P, or S. Alternatively, M may be B, Ga, Ge, P, or Sn. Alternatively, M may be Ge. Each X is independently a halogen or hydrogen atom, with the proviso that at least one X is a halogen atom. Each X may be independently selected from the group consisting of H, Cl, Br, F, and I. Alternatively, X may be H, Cl, Br, or I. Alternatively, X may be Cl. Subscript a has a value matching the valence of the element selected for M. For example, when M is Ge, subscript a may be 4. Examples of the halide include, but are not limited to, H₂GeCl₂, HGeCl₃, GeCl₄, and combinations thereof. Examples of the halide include, but are not limited to, GeCl₄, GeBr₄, Gel₄, and GeF₄ all of which are commercially available from Sigma-Aldrich, Inc. of St. Louis, Mo., U.S.A.

The reactor for step (i) can be any reactor suitable for the combining of gases and solids. For example, the reactor configuration can be a batch vessel, packed bed, stirred bed, vibrating bed, moving bed, re-circulating beds, or a fluidized bed. When using re-circulating beds, the M-containing transition metal catalyst can be circulated from a bed for conducting step (i) to a bed for conducting step (ii). To facilitate reaction, the reactor should have means to control the temperature of the reaction zone.

The temperature at which the hydrogen and the halide are contacted with the transition metal catalyst in step (i) may range from 200° C. to 1400° C.; alternatively 500° C. to 1400° C.; alternatively 600° C. to 1200° C.; and alternatively 650° C. to 1100° C.

The pressure at which the hydrogen and the halide are contacted with the transition metal catalyst in step (i) can be sub-atmospheric, atmospheric, or super-atmospheric. For example, the pressure may range from 100 kPag to 2000 kPag; alternatively 100 kPag to 1000 kPag; and alternatively 100 kPag to 800 kPag.

The mole ratio of hydrogen to halide contacted with the transition metal catalyst in step (i) may range from 10,000:1 to 0.01:1, alternatively 100:1 to 1:1, alternatively 20:1 to 2:1, and alternatively 20:1 to 5:1.

The residence time for the hydrogen and halide is sufficient for the hydrogen and halide to contact the transition metal catalyst and form the M-containing transition metal catalyst. For example, a sufficient residence time for the hydrogen and halide may be at least 0.01 s, alternatively at least 0.1 s, alternatively 0.1 s to 10 min, alternatively 0.1 s to 1 min, and alternatively 0.5 s to 10 s. The desired residence time may be achieved by adjusting the flow rate of the hydrogen and the halide, or by adjusting the total reactor volume, or by any combination thereof.

The hydrogen and the halide may be fed to the reactor simultaneously; however, other methods of combining, such as by separate pulses, are also envisioned.

The transition metal catalyst is in a sufficient amount. A sufficient amount of transition metal catalyst is enough transition metal catalyst to form the M-containing transition metal catalyst, described below, when the hydrogen and the halide are contacted with the transition metal catalyst. For example, a sufficient amount of transition metal catalyst may be at least 0.01 mg catalyst/cm³ of reactor volume; alternatively at least 0.5 mg catalyst/cm³ of reactor volume, and alternatively 1 mg to 10,000 mg catalyst/cm³ of reactor volume.

There is no upper limit on the time for which step (i) is conducted. For example, step (i) is usually conducted for at least 0.1 s, alternatively from 1 s to 5 hr, alternatively from 1 min to 1 hr.

In step (ii) of the method described herein, the M-containing transition metal catalyst prepared in step (i) is contacted with an organohalide at a temperature ranging from 100° C. to 600° C. to form a product comprising an organofunctional compound. The organofunctional compound comprises at least one species of formula R_{b}M_{c}X_{d}, where each R is independently a monovalent organic group, subscript b is 1 or more, subscript c is 1 or more, subscript d is 0 or more, and a quantity (b+d) has a value matching the valence of M_{c}.

The M-containing transition metal catalyst comprises at least 0.1%, alternatively 0.1% to 90%, alternatively 1% to 20%, alternatively 1% to 5%, based on the total weight of M-containing transition metal catalyst including any support, of the element selected for M, as defined above. The percentage of M in the M-containing transition metal catalyst can be determined using standard analytical tests. For example, the percentage of M may be determined using ICP-AES and ICP-MS.

The organohalide used in step (ii) has the formula RX, wherein R is a monovalent organic group. R may be selected from the group consisting of an alkyl group, an aralkyl group, an alkenyl group, an alkynyl group, and a carbocyclic group, as defined above. Alternatively, R may be an alkyl group or a cycloalkyl group. X is a halogen atom as defined above for the halide, and X in the organohalide may be the same or different as the halide used in step (i). The alkyl groups for R may have 1 to 10 carbon atoms, alternatively 1 to 6 carbon atoms, and alternatively 1 to 4 carbon atoms. The cycloalkyl groups represented by R may have 4 to 10 carbon atoms, alternatively 6 to 8 carbon atoms. Alkyl groups containing at least three carbon atoms can have a branched or unbranched structure. Examples of the organohalide include, but are not limited to, methyl chloride, methyl bromide, methyl iodide, ethyl chloride, ethyl bromide, ethyl iodide, cyclobutyl chloride, cyclobutyl bromide, cyclohexyl chloride, and cyclohexyl bromide.

The reactors suitable for use in step (ii) are as described for step (i). The same reactor may be used for step (i) as used in step (ii). Alternatively, separate reactors may be used for steps (i) and (ii). When separate reactors are used, the type of reactor in each step may be the same or different.

In step (ii), the organohalide may be contacted with the M-containing transition metal catalyst by feeding the organohalide into a reactor containing the M-containing transition metal catalyst produced in step (i).

The residence time of the organohalide is sufficient for the organohalide to react with the M-containing transition metal catalyst to form an organofunctional compound in step (ii). For example, a sufficient residence time of the organohalide may be at least 0.01 s, alternatively at least 0.1 s, alternatively 0.5 s to 10 min, alternatively 1 s to 1 min, alternatively 1 s to 10 s. The desired residence time can be achieved by adjusting the flow rate of the organohalide.

The temperature at which organohalide is contacted with the M-containing transition metal catalyst in step (ii) may range from 100° C. to 600° C., alternatively 200° C. to 500° C., and alternatively 250° C. to 375° C.

Step (ii) is typically conducted until the amount of element M in the M-containing transition metal catalyst falls below a predetermined limit, e.g., until the M-containing transition metal catalyst is spent, as described below. For example, step (ii) may be conducted until the M in the M-containing transition metal catalyst is below 90%, alternatively 1% to 90%, alternatively 1% to 40%, of its initial weight percent, based on the total weight of catalyst including any support. The initial weight percent of M in the M-containing transition metal catalyst is the weight percent of element M in the M-containing transition metal catalyst before the M-containing transition metal catalyst is contacted with the organohalide in step (ii). The amount of element M in the M-containing transition metal catalyst can be monitored by correlating the organofunctional compound (i.e., product of step (ii)) production with the weight percent of element M in the M-containing transition metal catalyst and then monitoring the organofunctional compound production or may be determined as described above for the M-containing transition metal catalyst.

The pressure at which the organohalide is contacted with the M-containing transition metal catalyst in step (ii) can be sub-atmospheric, atmospheric, or super-atmospheric. For example, the pressure may range from 100 kPag to 2000 kPag; alternatively 100 kPag to 1000 kPag; alternatively 100 kPag to 800 kPag.

The M-containing transition metal catalyst is present in a sufficient amount. A sufficient amount of M-containing transition metal catalyst is enough M-containing transition metal catalyst to form the organofunctional compound, described herein, when the M-containing transition metal catalyst is contacted with the organohalide. For example, a sufficient amount of M-containing transition metal catalyst may be at least 0.01 mg catalyst/cm³ of reactor volume; alternatively at least 0.5 mg catalyst/cm³ of reactor volume; alternatively 1 mg to 10,000 mg catalyst/cm³ of reactor volume.

The method described herein may optionally further comprise purging before contacting the M-containing transition metal catalyst with the organohalide in step (ii) and/or before contacting of the re-formed M-containing transition metal catalyst with the organohalide in step (iv), described below. The purging step comprises introducing a gas stream into the reactor containing the M-containing transition metal catalyst to remove unwanted materials. Unwanted materials are, for example, H₂, O₂, and H₂O. Purging may be accomplished with an inert gas, such as argon, or with a reactive gas, such as GeCl₄, which reacts with moisture, thereby removing it.

In step (ii) the M-containing transition metal catalyst and the organohalide may be contacted in the absence of hydrogen, in the absence of the halide of formula MXₐ, or in the absence of both the hydrogen and the halide.

The method may optionally further comprise steps (iii) and (iv) after step (ii). The purpose of steps (iii) and (iv) is to recycle spent M-containing transition metal catalyst by repeating steps (i) and (ii) using spent M-containing transition metal catalyst in place of the transition metal catalyst used in step (i). Spent M-containing transition metal catalyst refers to the M-containing transition metal catalyst after it has been contacted with the organohalide in step (ii) (or after step (iv), when step (iv) is present in the method). The spent M-containing transition metal catalyst after step (ii) contains an amount of element M less than the amount of element M in the M-containing transition metal catalyst after step (i) and before beginning step (ii). The spent M-containing transition metal catalyst left after step (iv) contains an amount of M less than the amount of M in the M-containing transition metal catalyst produced in step (iii). For example, the reduction of M in the catalyst to below 90%, alternatively 1% to 90%, alternatively 1% to 40%, refers to the percent reduction of this value before the M-containing transition metal catalyst is considered spent. So, for example, if the M-containing transition metal catalyst contained 10% by weight of M after step (i) and before step (ii), and a 50% reduction was selected for deeming the catalyst to be spent after step (ii), the catalyst would be considered spent when the amount of M had been reduced by 50% and is now present at 5% by weight in the spent M-containing transition metal catalyst.

Step (iii) comprises contacting spent M-containing transition metal catalyst with the mixture comprising hydrogen gas and additional halide of formula MXₐ (as described for step (i), above) at a temperature ranging from 200° C. to 1400° C. to re-form the M-containing transition metal catalyst comprising at least 0.1% of element M. The additional halide may be more of the same halide used above in step (i). Alternatively, the additional halide may be a halide of formula MXₐ, where at least one of M, X, and a is different than M, X, and/or a used in the halide of step (i). Step (iv) comprises contacting the re-formed M-containing transition metal catalyst produced in step (iii) with the organohalide (as described for step (ii), above) at a temperature ranging from 100° C. to 600° C. to form the product comprising the organofunctional compound.

The method of the invention may optionally further comprise repeating steps (iii) and (iv) at least 1 time, alternatively from 1 to 10⁵ times, alternatively from 1 to 1,000 times, alternatively from 1 to 100 times, and alternatively from 1 to 10 times.

If the organohalide or the halide of formula MXₐ are liquids at or below standard temperature and pressure, the method may further comprise pre-heating and gasifying the organohalide and/or the halide by known methods before contacting the halide with the transition metal catalyst in step (i) and/or step (iii) or contacting the organohalide with the M-containing transition metal catalysts in step (ii) and/or step (iv). Alternatively, the process may further comprise bubbling the hydrogen through liquid halide of formula MXₐ, to vaporize the halide before contacting with the transition metal catalyst in step (i) and/or the spent M-containing transition metal catalyst in step (iii).

If the organohalide or the halide of formula MXₐ are solids at or below standard temperature and pressure, the method may further comprise pre-heating above the melting points and liquefying or vaporizing the organohalide and/or the halide prior to reacting it with hydrogen and bringing it in contact with the transition metal catalyst in step (i) and/or the spent M-containing transition metal catalyst in step (iii)

The method may optionally further comprise step (v). Step (v) comprises recovering at least one species of the organofunctional compound produced (i.e., product of step (ii) and/or step (iv)). The organofunctional compound may be recovered by, for example, removing gaseous product from the reactor followed by isolation by distillation.

The product produced by the method described above comprises at least one organofunctional compound of formula R_{b}M_{c}X_{d}, where each R is as defined above, subscript b is 1 or more, subscript c is 1 or more, subscript d is 0 or more and a quantity (b+d) has a value matching valence of M_{c}. The product may comprise an organofunctional compound in which subscript c is 1. The product may comprise an organofunctional compound in which subscript b is 2 and subscript d is 2. The product may comprise an organofunctional compound in which each R is independently a monovalent hydrocarbon group. The monovalent hydrocarbon group may be selected from the group consisting of alkyl, alkenyl, alkynyl, and carbocyclic groups. Alternatively, R may be an alkyl group or a cycloalkyl group. Alternatively, R may be an alkyl group. The product may comprise an organofunctional compound in which each R is an alkyl group and each X is Cl. Alternatively, when subscript c is 1, then subscript b is 1 to 4, and subscript d is 0 to 3. Alternatively, the product of step (ii) comprises at least one organofunctional compound of formula R₂MX₂.

Examples of species of the organofunctional compound prepared according to the method described above include, but are not limited to, dimethyldichlorogermane (i.e., (CH₃)₂GeCl₂), dimethyldibromogermane, dimethyldiiodogermane, dimethyldifluorogermane, diethyldichlorogermane, diethyldibromogermane, diethyldiiodogermane, dicyclohexyldichlorogermane, and dicyclohexyldibromogermane.

The process may also produce other organofunctional compounds, such as those having the formulae RₑHGeX₃₋ₑ, RGeX₃, and/or R₃GeX, where R and X are as defined above and subscript e is 1 or 2. The method may also produce hydrohalogermanium compounds (i.e., hydrohalogermanes), such as those having the formula HGeX₃, where X is as defined above.

The method described herein may offer the advantage of not producing large amounts of metal halide byproducts requiring costly disposal. Still further, the method may produce diorgano-, dihalo-functional compounds with good selectivity compared to other organofunctional compounds. Finally, the M-containing transition metal catalyst may be re-formed and reused in the method, and the re-forming and reuse may provide increasing organofunctional compound production and/or selectivity.

### EXAMPLES

These examples are intended to illustrate some embodiments of the invention and should not be interpreted as limiting the scope of the invention set forth in the claims. Reference examples should not be deemed to be prior art unless so indicated. The following ingredients were used in these examples: activated carbon, AuCl₃, MgCl₂.4H₂O, and HCl were purchased from Sigma-Aldrich Inc. CuCl₂.2H₂O was purchased from Alfa Aesar of Ward Hill, Massachusetts, U.S.A.

The reaction apparatus used in these examples comprised a 4.8 mm inner diameter quartz glass tube in a flow reactor. The reactor tube was heated using a Lindberg/Blue Minimite 2.54 cm tube furnace. Omega FMA 5500 mass flow controllers were used to control gas flow rates. A stainless steel GeCl₄ bubbler was used to introduce GeCl₄ into the H₂ gas stream. The amount of GeCl₄ in the H₂ gas stream was adjusted by changing the temperature of the GeCl₄ in the bubbler according to calculations using well-known thermodynamic principles. The reactor effluent passed through an actuated 6-way valve from Vici. When actuated, the 6-way valve would make a 100 uL injection effluent gases from the reactor onto a GC-MS made by Agilent to characterize the reaction products.

### Reference Example 1

The following ingredients, 0.165 g AuCl₃ and 0.21 g MgCl₂.4H₂O, were added to 0.25 mL HCl and 1 mL deionized water and allowed to dissolve. The resulting solution was added to 6.85 g CuCl₂.2H₂O with 6 mL additional deionized water. The resulting mixture was heated until all of the CuCl₂ dissolved. The solution was then added to 3.51 g activated carbon. Excess solution was drained off, and the mixture was dried at 170° C. for 24 hr to prepare a supported copper catalyst.

The copper catalyst prepared (0.84 g) was loaded into a quartz tube and placed in a stainless steel flow tube reactor inside the tube furnace described above. The catalyst was reduced for 2 hours at 500° C. under 100 sccm of H₂. The temperature was then increased to 850° C.

### Example 1

Step (i) was initiated by introducing GeCl₄ over the copper catalyst prepared in reference example 1 by first bubbling the 100 sccm of H₂ gas stream through liquid GeCl₄ at room temperature, giving 12 sccm GeCl₄ vapor flow rate. The resulting Ge-containing copper catalyst was then cooled to 300 C under 100 sccm H₂. The reactor was then purged with argon for 30 minutes.

Step (ii) was initiated by flowing 1 sccm MeCl over the Ge-containing copper catalyst at 300 C for 268 min. Methylated germanium compounds eluted from the reactor and were characterized. Characterization of the effluent of the reactor containing the products and byproducts was performed by passing the effluent through an actuated 6-way valve (Vici) with constant 100 uL injection loop before being discarded. Samples were taken from the reaction stream by actuating the injection valve and the 100 uL sample passed directly into the injection port of a 7890A Agilent GC-MS for analysis with a split ratio at the injection port of 100:1. The GC contained two 30 m SPB-Octyl columns (Supelco, 250 um inner diameter, 0.25 um thick film), which were placed in parallel such that the sample was split evenly between the two columns. One column went to a TCD for quantization of the reaction products and the other column went to a mass spectrometer (Agilent 7895C MSD) for sensitive detection of trace products and positive identification of any products that formed. The columns were heated by an Agilent LTM module (i.e., the columns were wrapped with heating elements and thermocouples such that they were precisely and rapidly ramped to the desired temperature). The Ge compounds that eluted, in order of abundance were Me₂GeCl₂>>MeGeCl₃>Me₃GeCl.

The cycle was repeated with step (iii) lasting 30 minutes and step (iv) lasting 120 minutes. The same germanium compounds eluted from the reactor in the same order of abundance.

The method described above may be used for preparing a diorganodihalogermane. The method may comprise the separate and consecutive steps of (i) contacting a copper catalyst with a mixture comprising hydrogen gas and a germanium halide at a temperature ranging from 200° C. to 1400° C. to form a Ge-containing copper catalyst comprising at least 0.1% of germanium, wherein the copper catalyst is selected from copper and a mixture comprising copper and at least one element selected from gold, magnesium, calcium, cesium, tin, and sulfur; and (ii) contacting the Ge-containing copper catalyst with an organohalide at a temperature ranging from 100° C. to 600° C. to form an organofunctional compound product comprising a diorganodihalogermanium compound, such as dimethyldichlorogermane.

1. A method comprises steps (i) and (ii), where:
step (i) is contacting a transition metal catalyst with a mixture comprising hydrogen gas and a halide of formula MXₐ, where M is an element selected from the group consisting of antimony, arsenic, bismuth, boron, cadmium, gallium, germanium, indium, lead, mercury, phosphorus, selenium, sulfur, tellurium, and tin; each X is independently a halogen atom or hydrogen atom, with the proviso that at least one X is a halogen atom, and subscript a has a value matching valence of M; at a temperature ranging from 200° C. to 1400° C. to form a M-containing transition metal catalyst comprising at least 0.1% of M; and
step (ii) is contacting the M-containing transition metal catalyst with an organohalide of formula RX, at a temperature ranging from 100° C. to 600° C. to form at least one organofunctional compound of formula R_{b}M_{c}X_{d}, where M and X are as described above, each R is independently a monovalent organic group, subscript b is 1 or more, subscript c is 1 or more, subscript d is 0 or more and a quantity (b+d) has a value matching valence of M_{c}.

2. The method of claim 1, wherein the transition metal catalyst used in step (i) is a copper catalyst selected from the group consisting of copper and a mixture comprising copper and at least one element selected from the group consisting of gold, magnesium, calcium, cesium, tin, and sulfur.

3. The method of claim 1, further comprising separate and consecutive steps (iii) and (iv), wherein steps (iii) and (iv) are performed after step (ii), and wherein
step (iii) is repeating step (i) but using additional hydrogen gas and additional halide and recycling a spent M-containing transition metal catalyst left after step (ii) to re-form the M-containing transition metal catalyst, and
step (iv) is repeating step (ii) but using the M-containing transition metal catalyst re-formed in step (iii) and additional organohalide.

4. The method of claim 3, further comprising repeating steps (iii) and (iv) at least once.

5. The method of claim 3, further comprising purging a reactor before the contacting of the re-formed M-containing transition metal catalyst with the additional organohalide in step (iv) in the reactor.

6. The method of claim 5, wherein the purging is conducted with argon or the additional halide.

7. The method of claim 1, further comprising purging before contacting the M-containing transition metal catalyst with the organohalide in step (ii).

8. The method of claim 7, wherein the purging is conducted with argon or the halide of formula MXₐ.

9. The method of claim 1, wherein in step (i) the transition metal catalyst is supported.

10. The method of claim 9, wherein the transition metal catalyst is a copper catalyst comprising from 0.1 to 35% of the mixture, and the mixture comprises copper, gold and magnesium.

11. The method of claim 9, wherein the transition metal catalyst is supported on activated carbon.

12. The method of claim 1, wherein the M-containing transition metal catalyst formed by step (i) comprises 1% to 5% of M.

13. The method of claim 1, wherein mole ratio of the hydrogen gas to the halide ranges from 20:1 to 5:1.

14. The method of claim 1, wherein each X is Cl.

15. The method of claim 1, wherein the organohalide has the formula RX, where R is an alkyl group of 1 to 10 carbon atoms or a cycloalkyl group of 4 to 10 carbon atoms, and X is F, Cl, Br, or I.

16. The method of claim 1, wherein the contacting in step (ii) is performed in the absence of hydrogen.

17. The method of claim 1, wherein the organofunctional compound comprises a species of formula R₂MX₂, where R is an alkyl of 1 to 10 carbon atoms or a cycloalkyl group of 4 to 10 carbon atoms, and X is F, Cl, Br, or I.

18. The method of claim 15, wherein R is methyl and X is Cl.

19. The method of claim 1, wherein M is Ge.

20. The method of claim 1, further comprising recovering the organofunctional compound.

21. (canceled)

22. (canceled)

23. (canceled)

24. (canceled)
